(19) United States
(12) Patent Application Publication
(10) Pub. No.: US 2003/0126553 A1
(43) Pub. Date: Jul. 3, 2003

(54) Document information processing method, document information processing apparatus, communication system and memory product

(76) Inventor: Yoshinori Nagata, Kitakatsuragi-gun (JP)

Correspondence Address: NIXON & VANDERHYE, PC, 1100 N GLEBE ROAD, 8TH FLOOR, ARLINGTON, VA, 22201-4714, US

(21) Appl. No.: 10/319,487

(22) Filed: Dec. 16, 2002

(30) Foreign Application Priority Data
Dec. 27, 2001 (JP) 2001-398405

(51) Int. Cl. G06F 15/00

(52) U.S. Cl. 715/500

(57) ABSTRACT

In a document information processing apparatus, intermediate information, which contains the same character information as in document information created by a document creation application and is used for reduction of the amount of the document information, is generated based on the document information, word information contained in the document information or in the intermediate information is extracted, and summary information is generated by adding the extracted word information to the intermediate information which was subjected to a reduction of amount of information according to the need. The generated summary information not only has a small data volume but also contains all the word information, and is therefore usable for a searching process using character information, such as full-text searching.

### BACKGROUND OF THE INVENTION

The present invention relates to a document information processing method for processing document information containing character information, a document information processing apparatus adopting the method, a communication system using the apparatus, and a memory product storing a computer program for realizing the apparatus, and more particularly relates to a document information processing method, a document information processing apparatus, a communication system and a memory product, for generating summary information which allows easy understanding of the content of document information of a large number of pages, a large data volume or the like.

A variety of document creation application programs for creating document information as electronic information (hereinafter referred to as “document creation applications”) are provided in the market, and document information containing a variety of information, such as character information, image information and graphic information formed in various formats, is created using such a document creation application. With the creation of increasing number of document information using the document creation applications, there has been demand for a system for efficiently using and managing the created document information.

For example, Japanese Patent Application Laid-Open No. 8-241306(1996) discloses a document information processing apparatus that creates attribute information containing information such as the creation date and character information of document information, and manages the document information by using the created attribute information. The attribute information created by the document information processing apparatus disclosed in Japanese Patent Application Laid-Open No. 8-241306(1996) has no dependency on the document creation application and allows a process such as keyword searching because the attribute information contains character information, and therefore it would have the effect of improving the efficiency of managing the document information.

However, since the attribute information created by the document information processing apparatus disclosed in Japanese Patent Application Laid-Open No. 8-241306(1996) tends to keep all the information such as formats contained in the original document information, there is a problem that the data volume is large. When the data volume of the attribute information is large, since there is a necessity of abandoning information corresponding to the late pages of the document information, the character information in the abandoned pages will also be deleted, and consequently there arises a problem that a searching process using character information, such as full-text searching, is infeasible.

### BRIEF SUMMARY OF THE INVENTION

The present invention has been made with the aim of solving the above problems, and it is an object of the present invention to provide a document information processing method, which generates intermediate information containing the same character information as in the original document information, extracts word information from the document information or the intermediate information, generates summary information by adding the extracted word information to the intermediate information, and particularly, when the data volume of the intermediate information is greater than a predetermined value set in advance, reduces information such as color number, typefaces and formats from the intermediated information so that the summary information obtained by adding the word information to the intermediate information has not only small data volume but also contains all the word information and is usable for a searching process using character information such as full-text searching, thereby capable of efficiently using and managing the document information; a document information processing apparatus adopting the method; a communication system using the apparatus; and a memory product storing a computer program for realizing the apparatus.

A document information processing method according to the first aspect is a document information processing method for processing document information containing character information, generating intermediate information containing the same character information as in the document information, based on the document information, extracting word information representing words from the document information or the intermediate information, and generating summary information by adding the extracted word information to the intermediate information. In the document information processing method of the first aspect, since the summary information is generated by adding the word information to the intermediate information whose data volume is small, the generated summary information has not only a small data volume but also contains all the word information, and therefore the summary information can be used for a searching process using character information, such as full-text searching. Accordingly, it is possible to efficiently use and manage the document information that is the source of the summary information.

A document information processing apparatus according to the second aspect is a document information processing apparatus for processing document information containing character information, and comprises: means for generating intermediate information containing the same character information as in the document information, based on the document information; means for extracting word information representing words from the character information contained in the document information or in the generated intermediate information; and means for generating summary information by adding the extracted word information to the intermediate information. In the document information processing apparatus of the second aspect, since the summary information is generated by adding the word information to the intermediate information, the generated summary information contains all the word information, and therefore the summary information can be used for a searching process using character information, such as full-text searching. Accordingly, it is possible to efficiently use and manage the document information that is the source of the summary information.

A document information processing apparatus according to the third aspect is based on the second aspect, and comprises: means for measuring the amount of the intermediate information; means for comparing the measured amount of the intermediate information with a predetermined value set in advance; and means for reducing the amount of the intermediate information when the amount of the intermediate information is judged to be greater than the predetermined value. Since the information contained in the intermediate information is reduced when the amount such as the data volume of the intermediate information is greater than the predetermined value, it is possible to prevent an increase in the data volume of the summary information.

In a document information processing apparatus according to the fourth aspect, the reducing means in the third aspect includes a reduction method of deleting a part of the intermediate information. Since a part of the intermediate information is deleted, it is possible to decrease the data volume of the summary information.

In a document information processing apparatus according to the fifth aspect, the part of the intermediate information in the fourth aspect is information about late pages of a document shown by the intermediate information, and it is possible to efficiently confirm the content of the document information from a part of the summary information, showing the intermediate information, by leaving the top part that is the introduction part of the document as the intermediate information.

In a document information processing apparatus according to the sixth aspect, the reducing means of any one of the third through fifth aspects includes a reduction method of converting information about color. By reducing the information about color such as color number and tint, for example, by converting a 24-bit color image into a gray-scale image, it is possible to decrease the data volume of the summary information.

In a document information processing apparatus according to the seventh aspect, the reducing means of any one of the third through sixth aspects includes a reduction method of converting information about typefaces of character information. By reducing the information about typefaces such as Mincho type and Gothic type, it is possible to decrease the data volume of the summary information.

In a document information processing apparatus according to the eighth aspect, the reducing means of any one of the third through seventh aspects includes a reduction method of converting information about formats of a document. By reducing the information about formats such as the number of lines, number of figures and margins, it is possible to decrease the data volume of the summary information.

In a document information processing apparatus according to the ninth aspect is based on any one of the third through eighth aspects, wherein the document information contains information about graphics, and the reducing means includes a reduction method of converting the information about graphics. By reducing the information about graphics, particularly line width and line type of a line drawing, it is possible to decrease the data volume of the summary information.

In a document information processing apparatus according to the tenth aspect, the reducing means in any one of the third through ninth aspects comprises the steps of reducing the amount of the intermediate information by a first reduction method; comparing the amount of the intermediate information after the reduction with the predetermined value; further reducing the amount of the intermediate information by a second reduction method different from the first reduction method when the amount of the intermediate information is judged to be greater than the predetermined value by the comparison. When the document information processing apparatus includes a plurality of reduction methods, the respective reduction methods are executed sequentially, and therefore it is possible to prevent an increase in the data volume of the summary information.

A document information processing apparatus according to the eleventh aspect, further comprises means for accepting a priority order of the reduction methods of the tenth aspect, and the reducing means reduces the amount of the intermediate information according to the accepted priority order. By setting the order of executing a plurality of reduction methods and limiting the execution of a particular reduction method according to the need, it is possible to generate summary information according to the use situation of a user.

A document information processing apparatus according to the twelfth aspect is based on any one of the second through eleventh aspects, and comprises: means for generating image information by irreversibly compressing the document information; means for comparing amounts of the generated image information and the intermediate information; and means for replacing the image information as new intermediate information when the amount of the image information is judged to be smaller than the amount of the intermediate information by the comparison. By generating image information such as a thumbnail image which is image information reduced in the display size and irreversibly compressed in a format such as JPEG and GIF, based on the document information, and using the image information as the intermediate information when the data volume of the generated image information is smaller than the amount of the intermediate information, it is possible to reduce the summary information.

A document information processing apparatus according to the thirteenth aspect is a document information processing apparatus for processing document information containing character information, and comprises: means for generating image information by irreversibly compressing the document information; means for extracting word information representing words from the character information contained in the document information; and means for generating summary information by adding the extracted word information to the generated image information. In the document information processing apparatus of the thirteenth aspect, since the image information such as a thumbnail image which is image information reduced in the display size and irreversibly compressed in a format such as JPEG and GIF is generated based on the document information and the summary information is generated by adding the word information to the generated image information, the generated summary information has not only a small data volume but also contains all the word information, and therefore the summary information can be used for a searching process using character information, such as full-text searching. Accordingly, it is possible to efficiently use and manage the document information that is the source of the summary information.

In a document information processing apparatus according to the fourteenth aspect, the extracting means in any one of the second through thirteenth aspects extracts independent words, which are extracted by a morpheme analysis, as word information from the character information. By extracting the word information by using the morpheme analysis, it is possible to extract word information for use in efficient searching with respect to the document information created in a language.

A document information processing apparatus according to the fifteenth aspect is based on any one of the second through fourteenth aspects, and comprises means for reversibly compressing the generated summary information. By performing reversible compression in a format such as ZIP, LZH, and CAB, it is possible to decrease the data volume of the summary information.

A communication system according to the sixteenth aspect comprises: the document information processing apparatus of any one of the second through fifteenth aspects; a communication apparatus for communicating with the document information processing apparatus; and a recording apparatus for communicating with the document information processing apparatus and communication apparatus, wherein the document information processing apparatus includes: means for recording the document information in the recording apparatus; and means for transmitting indication information specifying a position where the document information is recorded and the summary information, to the communication apparatus. In the communication system of the sixteenth aspect, by recording the original document information in the recording apparatus using a server computer and transmitting the summary information to the communication apparatus using a client computer, an operator who operates the communication apparatus can confirm the summary information, and order the document information from the recording apparatus only when the document information is judged to be necessary, thereby making it possible to reduce the communication load and the capacity load in the communication apparatus. In particular, the reduction of the communication load is valid by transmitting the summary information simultaneously to a plurality of communication apparatuses.

A computer readable memory product according to the seventeenth aspect is a computer readable memory product storing a computer program for causing a computer to process document information containing character information, wherein the memory product stores a computer program comprising the steps of causing the computer to generate intermediate information containing the same character information as in the document information, based on the document information; causing the computer to extract word information representing words from the document information or the intermediate information; and causing the computer to generate summary information by adding the extracted word information to the intermediate information. With the memory product of the seventeenth aspect, by executing the stored computer program by a computer such as a general-purpose client computer, the computer operates as a document information processing apparatus. Thus, by generating summary information by adding word information to intermediate information, the generated summary information contains all the word information, and therefore it can be used for a searching process using character information such as full-text searching. Accordingly, it is possible to efficiently use and manage the document information that is the source of the summary information.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing the structure of a document information processing apparatus of the present invention;

FIG. 2 is a flow chart showing the outline of a summary information generating process of the document information processing apparatus of the present invention;

FIG. 3 is a concept view showing the structure of intermediate information generated by the document information processing apparatus of the present invention;

FIG. 4 is an explanatory view showing an image outputted from the document information processing apparatus of the present invention;

FIG. 5 is a flow chart showing the summary information generating process of the document information processing apparatus of the present invention;

FIG. 6 is a flow chart showing the summary information generating process of the document information processing apparatus of the present invention;

FIG. 7 is a flow chart showing the summary information generating process of the document information processing apparatus of the present invention;

FIG. 8 is a concept view showing the structure of summary information generated by the document information processing apparatus of the present invention;

FIG. 9 is a flow chart showing a summary information generating process based on image information of the document information processing apparatus of the present invention;

FIG. 10 is a concept view showing a communication system of the first embodiment of the present invention;

FIG. 11 is a block diagram showing the structure of the communication system of the first embodiment of the present invention;

FIG. 12 is a flow chart showing a document information recording process of the document information processing apparatus, recording apparatus and communication apparatus used in the communication system of the first embodiment of the present invention;

FIG. 13 is a flow chart showing a document information request process of the recording apparatus and communication apparatus used in the communication system of the first embodiment of the present invention;

FIG. 14 is an explanatory view showing images outputted from the communication apparatus used in the communication system of the first embodiment of the present invention;

FIG. 15 is an explanatory view showing images outputted from the communication apparatus used in the communication system of the first embodiment of the present invention;

FIG. 16 is an explanatory view showing an image outputted from the communication apparatus used in the communication system of the first embodiment of the present invention; and

FIG. 17 is a concept view showing a communication system of the second embodiment of the present invention.

### DETAILED DESCRIPTION OF THE INVENTION

The following description will describe the present invention in detail, based on the drawings illustrating a mode of the invention.

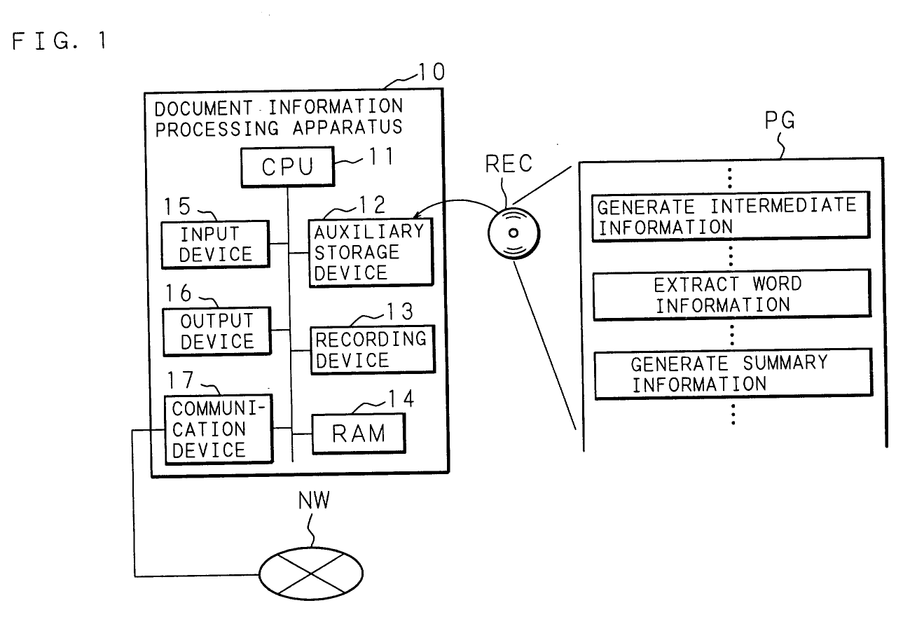

FIG. 1 is a block diagram showing the structure of a document information processing apparatus of the present invention. In FIG. 1, the numeral 10 represents a document information processing apparatus of the present invention using a client computer, and the document information processing apparatus 10 is connected to a network NW, such as an internal network (LAN). The document information processing apparatus 10 comprises an auxiliary storage device 12 for reading various recorded information from a memory product REC such as a CD-ROM drive in which various information such as a computer program PG and data is recorded; and a recording device 13 such as a hard disk for recording various information read by the auxiliary storage device 12. By reading various information such as the computer program PG and data from the recording device 13, storing the information in a RAM 14 for temporarily storing information, and executing the information by a CPU 11, the client computer operates as the document information processing apparatus 10 of the present invention.

In addition, the document information processing apparatus 10 comprises an input device 15 such as a mouse and a keyboard; an output device 16 such as a monitor and a printer; and a communication device 17 such as a LAN board. Moreover, the recording device 13 stores not only the computer program PG of the present invention, but also various computer programs such as a document creation application for creating electronic documents and a virtual printer driver which is necessary for conversion of document information as described later.

Next, the following description will explain summary information generated by the document information processing apparatus 10 of the present invention. The document information processing apparatus 10 of the present invention, based on an electronic document created using the document creation application, has the function of generating summary information which allows understanding of the outline of the document and is usable for a searching process using character information such as full-text searching, by a later-described method.

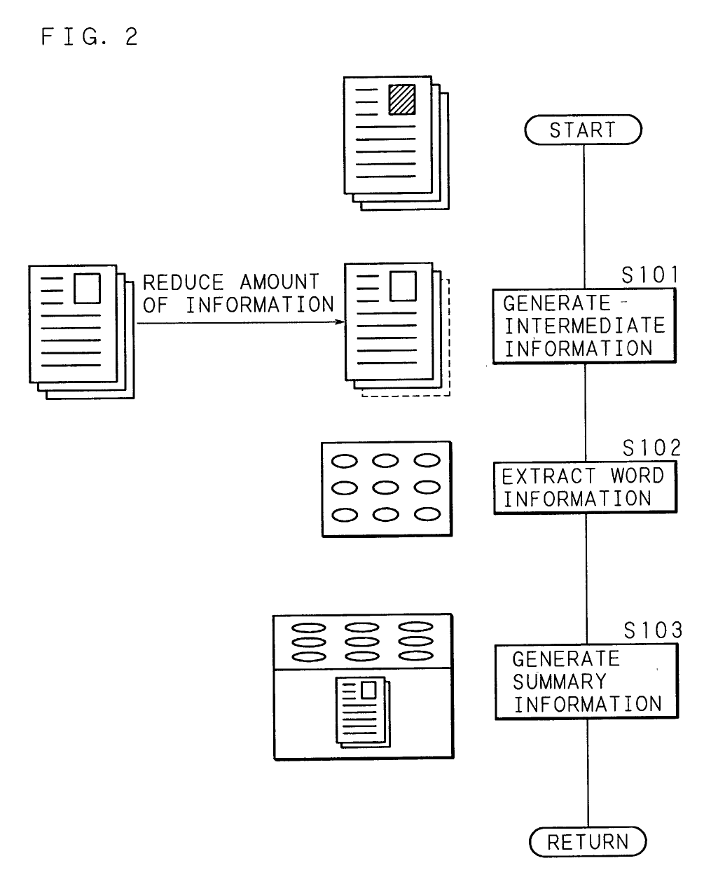

FIG. 2 is a flow chart showing the outline of a summary information generating process of the document information processing apparatus 10 of the present invention. In the document information processing apparatus 10, based on the document information created by the document creation application as described above, intermediate information which contains the same character information as in the document information and is used to reduce the amount of the document information is generated (S101). Note that the intermediate information is subjected to a reduction of the amount of information according to the need. Moreover, word information contained in the document information is extracted (S102), and summary information is generated by adding the extracted word information to the intermediate information which was subjected to a reduction of amount of information according to the need (S103).

The intermediate information generated in step S101 is information which includes the contents constituting the document information and does not depend on the document creation application used. Information such as attribute information disclosed in Japanese Patent Application Laid-Open No. 8-241306(1996) corresponds to such intermediate information. In other words, there are various types of document creation applications, and document information as an electronic document created using one type of document creation application depends highly on the one type of document creation application used to create the document, and often can not be outputted by other type of document creation application. Therefore, there is executed a process of generating intermediate information which does not depend on a particular document creation application and can be outputted by other type of document creation application, based on the document information as the electronic document created using one type of document creation application. As one method of generating the intermediate information which does not depend on a particular document creation application, in the case where the information is to be outputted from the output device 16 that is a printer, there is a method using the function of converting the document information into a format capable of being outputted from the output device 16.

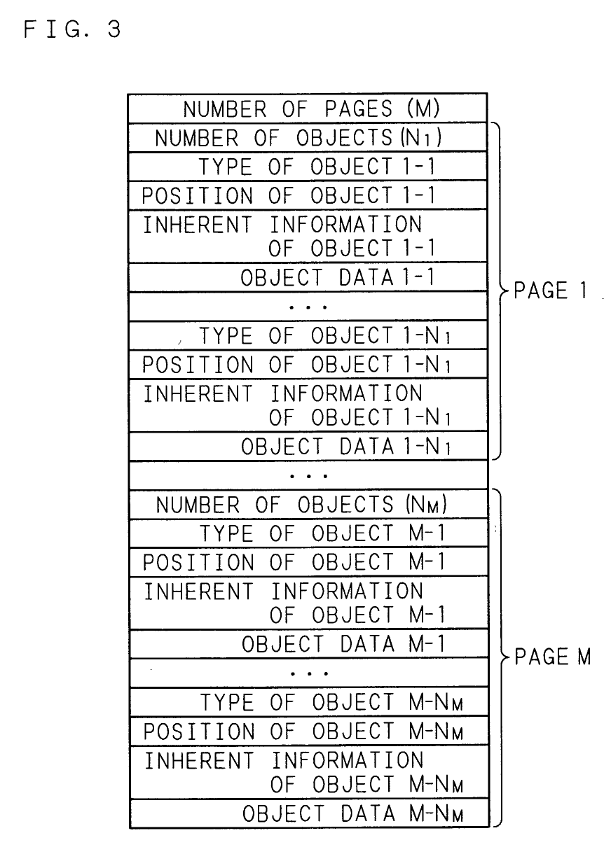

FIG. 3 is a concept view showing the structure of the intermediate information generated by the document information processing apparatus 10 of the present invention. The intermediate information generated based on the document information as shown in FIG. 3 is composed of information representing the number of pages M and information of each page, showing the content of each of the pages from page 1 to page M. Illustrated as the information showing the content of each page are information indicating the number N of objects such as character strings, line drawings and images which are the elements constituting a document of each page, and information such as the type, position and inherent information of each object and data indicating the content of the object. As the inherent information, when the object is a line drawing, for example, information such as line width and line type is shown.

In the case of generating the intermediate information having the structure shown in FIG. 3 by using the function of converting the document into a format capable of being outputted from the output device 16, as a method of operating the document information processing apparatus 10, an operation to output the virtual printer driver recorded in the recording device 13 to a virtual printer set as an interface is performed, and then the document information processing apparatus 10 accepts the operation and generates the intermediate information based on the document information, according to the processes of the virtual printer driver.

Note that the conversion method performed by assuming a virtual printer by the virtual printer driver is merely one example, and it is also possible to perform the conversion by other method. However, the purpose of the generation of the intermediate information which does not depend on a particular document creation application is to generate summary information which does not depend on a particular document creation application. Therefore, if high dependency on a particular document creation application is acceptable, more specifically, under the condition where only a particular document creation application is used, such as the case where the summary information to be used only on a particular document information processing apparatus 10 is generated and the case where a standardized document creation application is used, it is possible to generate the intermediate information having the same content as the document information as temporary information (temporary file) and use this information as the intermediate information based on the document information.

Next, the following description will explain in detail a summary information generating process of the document information processing apparatus 10 of the present invention. An operator who wishes to generate the summary information based on the document information by operating the document information processing apparatus 10 selects reduction methods for reducing the data volume of the intermediate information, and inputs the priority order for the selected reduction methods.

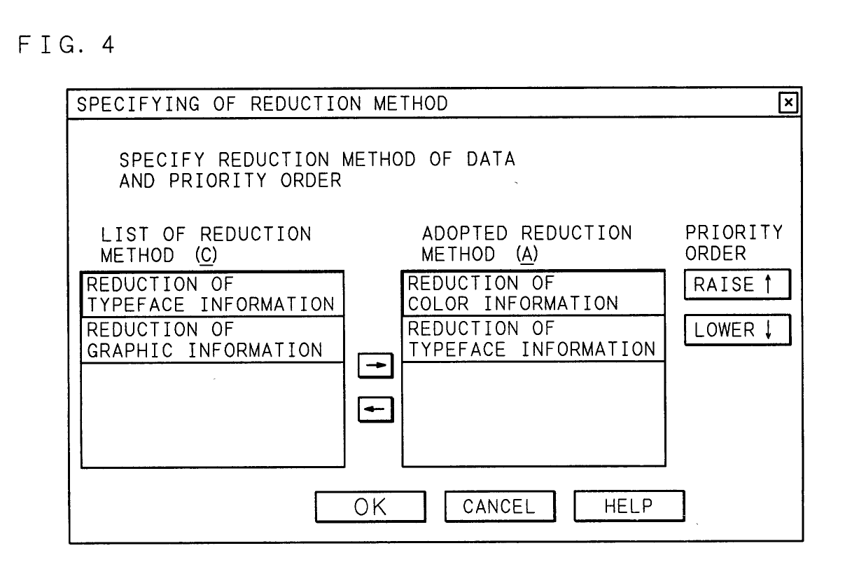

FIG. 4 is an explanatory view showing an image outputted from the document information processing apparatus 10 of the present invention. In FIG. 4, an image for selecting reduction methods and specifying the priority order is shown. By selecting a desired reduction method from a list of reduction methods shown in the left window and clicking an arrow representing addition, the reduction method is selected and moved to the right window as an adopted reduction method. On the other hand, when deleting a selected reduction method, a reduction method desired to be deleted is selected from a list of adopted reduction methods shown in the right window and an arrow representing deletion is clicked, so that the selected reduction method is moved to the left window. In the list of adopted reduction methods shown in the right window, the reduction methods are listed sequentially in a descending order from a reduction method of the highest priority order to a reduction method of the lowest priority order, and the priority order can be changed by clicking an arrow representing “raising the priority order” or an arrow representing “lowering the priority order”. Then, by clicking a section indicated with “OK”, the document information processing apparatus 10 completes the selection of reduction methods and the specifying of the priority order, and starts to generate the summary information.

Note that, in the following explanation, reduction of color information, reduction of typeface information, reduction of format information and reduction of graphic information are selected as reduction methods, and the priority order is specified for the reduction of color information, reduction of typeface information, reduction of format information and reduction of graphic information in this order so that the reduction of color information has the highest priority. However, the reduction methods of the document information processing apparatus 10 of the present invention are not necessarily limited to the above-mentioned methods, and it is also not necessarily to select all the reduction methods.

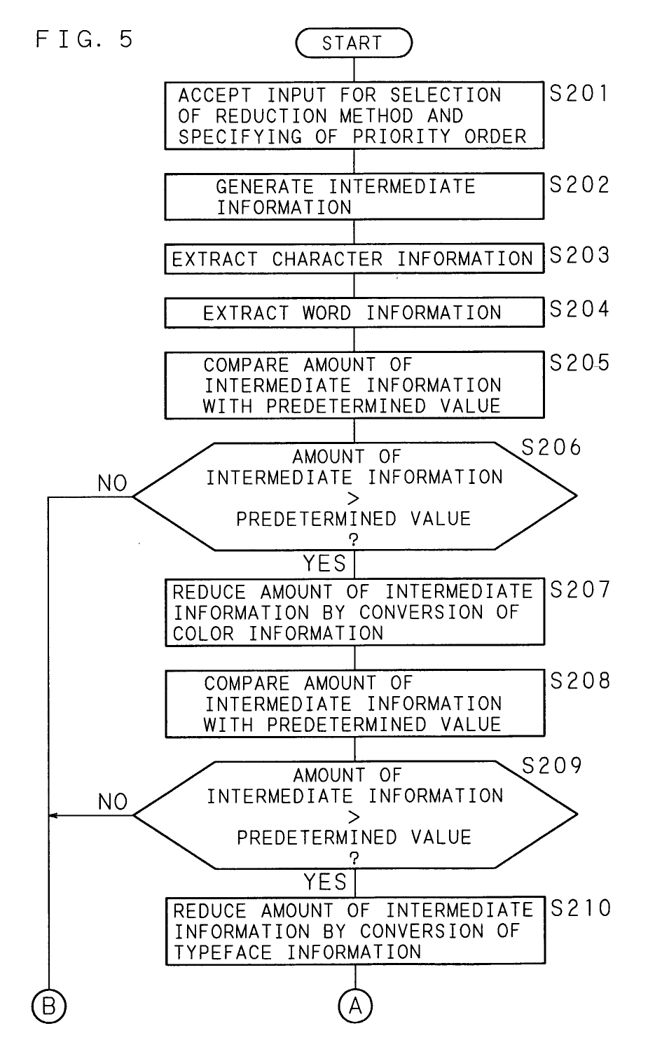

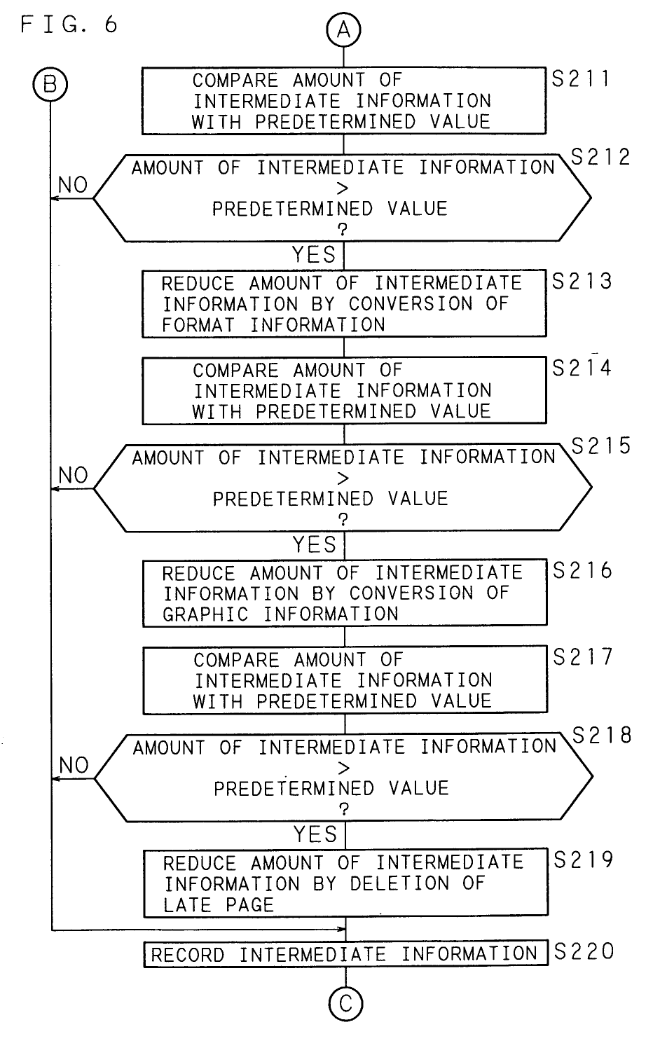

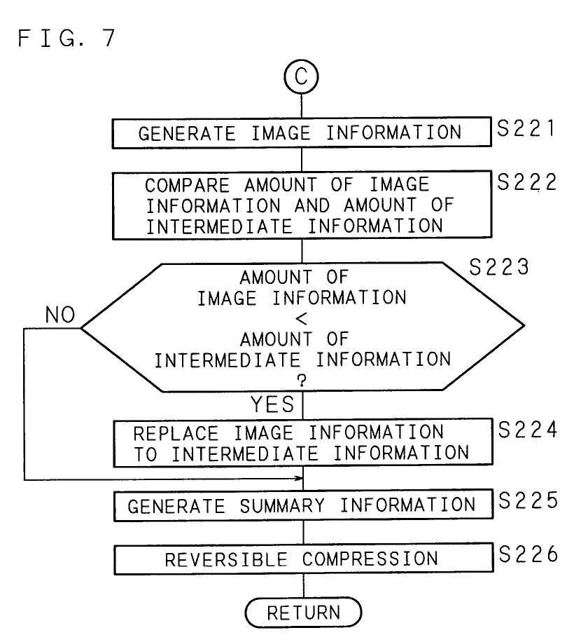

FIGS. 5 through FIG. 7 are flow charts showing the summary information generating process of the document information processing apparatus 10 of the present invention. The document information processing apparatus 10 accepts inputs for the selection of reduction methods and specifying of the priority order (S201), generates the intermediate information containing the same character information as in the document information, based on the document information (S202), extracts the character information from the document information or the intermediate information generated in step S202(S203), and extracts independent words as word information from the extracted character information by a morpheme analysis (S204). By this morpheme analysis, words with conjugated forms, such as verbs, are converted into their basic forms.

As the source information from which the character information is extracted in step S203, the document information is basically used. However, it is also possible to regard the intermediate information, which contains the same character information as in the document information and is generated in step S202, as the document information, and to extract the character information from the intermediate information. However, as to be described later, since the intermediate information after a reduction of information does not necessarily contain the same character information as in the document information, the character information must be extracted from the intermediate information before the reduction of information.

Then, the amount of the generated intermediate information, such as the number of pages and the data volume, is compared with a predetermined value set in advance(S205). When the amount is judged to be greater than the predetermined value by the comparison in step S205 (S206: YES), the amount of the intermediate information is reduced by a reduction method of the first priority order, here, the conversion of information about color such as color number and tint, for example, a reduction method of converting a 24-bit color image into a gray-scale image (S207), and the amount of the intermediate information after the reduction of amount of information is compared with the predetermined value (S208).

When the amount of the intermediate information is judged to be greater than the predetermined value by the comparison in step S208 (S209: YES), according to the specified priority order, the amount of the intermediate information which was subjected to a reduction in the amount of information in step S207 is further reduced by a reduction method of the second priority order, here, a reduction method of converting information about typefaces such as Mincho type and Gothic type (S210), and then the amount of the intermediate information after the reduction of amount of information is compared with the predetermined value (S211).

When the amount of the intermediate information is judged to be greater than the predetermined value by the comparison in step S211 (S212: YES), according to the specified priority order, the amount of the intermediate information which was subjected to a reduction in the amount of information in step S210 is further reduced by a reduction method of the third priority order, here, a reduction method of converting information about formats such as the number of lines, the number of figures and margins (S213), and then the amount of the intermediate information after the reduction of amount of information is compared with the predetermined value (S214).

When the amount of the intermediate information is judged to be greater than the predetermined value by the comparison in step S214 (S215: YES), according to the specified priority order, the amount of the intermediate information which was subjected to a reduction in the amount of information in step S213 is further reduced by a reduction method of the fourth priority order, here, a reduction method of converting information about graphics, particularly line width and line type (S216), and then the amount of the intermediate information after the reduction of amount of information is compared with the predetermined value (S217). Note that, at this time, although the information about line width and line type of the rules and the graphics in the document is also reduced, it is also possible to include the information about line width and line type of the rules in the information about formats and arrange the graphics to be deleted by another process.

When the amount of the intermediate information is judged to be greater than the predetermined value by the comparison in step S217 (S218: YES), the amount of the intermediate information which was subjected to a reduction in the amount of information in step S216 is further reduced by a reduction method of deleting information of late pages which is a part of the document shown by the intermediate information (S219), and then the intermediate information is temporarily recorded in the recording device 13 or the RAM 14 (S220). The process of deleting the information of late pages shown in step S219 is executed even when this process is not selected in advance. However, on the contrary, by setting not to perform a reduction of information about pages beforehand, it is also possible not to perform the process shown in step 219 even when the final amount of the intermediate information exceeds the predetermined value.

When the amount of the intermediate information is judged to be smaller than the predetermined value by the comparison in step S205 (S206: NO), when the amount of the intermediate information is judged to be smaller than the predetermined value by the comparison in step S208 (S209: NO), when the amount of the intermediate information is judged to be smaller than the predetermined value by the comparison in step S211 (S212: NO), when the amount of the intermediate information is judged to be smaller than the predetermined value by the comparison in step S214 (S215: NO), or when the amount of the intermediate information is judged to be smaller than the predetermined value by the comparison in step S217 (S218: NO), the intermediate information is temporarily recorded without performing subsequent reduction processes (S220).

Then, based on the document information, image information which is reduced in the display size and irreversibly compressed in a format such as JPEG and GIF, i.e., image information such as a thumbnail image, is generated (S221), and the amount of the generated image information and the amount of the intermediate information recorded in step S220 are compared (S222). Note that it is also possible to generate image information based on the intermediate information generated in step S202, instead of generating the image information based on the document information, and use the generated information for the comparison of amount.

When the amount of the image information is judged to be smaller than the amount of the intermediate information by the comparison in step S222 (S223: YES), the image information is replaced as new intermediate information (S224), and temporarily recorded. Note that, when the amount of the image information is judged to be greater than the amount of the intermediate information by the comparison in step S222 (S223: NO), the replacement of the intermediate information is not performed. Then, the word information extracted in step S204 is added to the temporarily stored intermediate information to generate the summary information (S225). Thus, the summary information is generated.

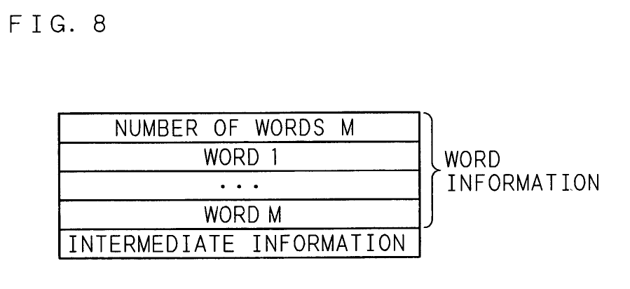

FIG. 8 is a concept view showing the structure of the summary information generated by the document information processing apparatus 10 of the present invention. The summary information contains information indicating the number of words M and the words from word 1 to word M extracted from the document information as the word information, and further contains the intermediate information which was subjected to a reduction of amount of information according to the need. Note that the generated summary information is reversibly compressed in a format, such as ZIP, LZH and CAB, for a further reduction of the amount (S226).

In the above-described mode, while a mode using the intermediate information including various objects such as colors, typefaces, formats and graphics of the document information is illustrated, the present information is not necessarily limited to this mode and may be used in a mode in which the summary information is generated based on image information such as a thumbnail image generated from the document information, without performing the reduction processes with respect to various objects.

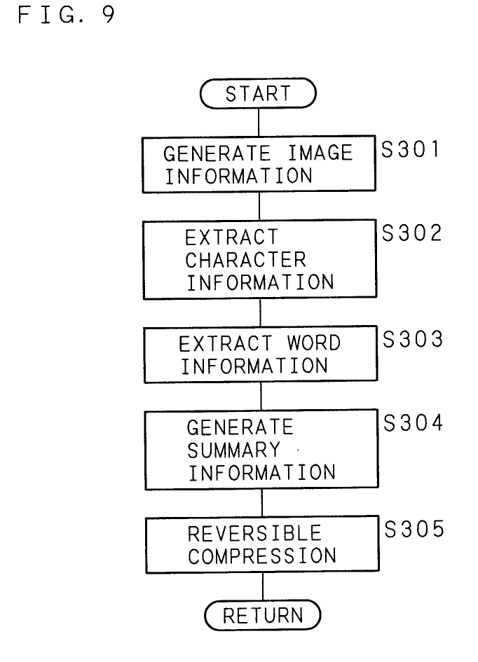

Next, the following description will explain a process of generating the summary information without performing reduction processes with respect to various objects. FIG. 9 is a flow chart showing the summary information generating process based on image information of the document information processing apparatus 10 of the present invention.

In the document information processing apparatus 10, image information such as a thumbnail image is generated based on the document information (S301). Moreover, character information is extracted from the document information (S302), and independent words as word information are extracted from the extracted character information by a morpheme analysis (S303). Subsequently, the extracted word information is added to the image information generated in step S301 to generate summary information (S304), and further the summary information is reversibly compressed (S305). Note that it is also possible to generate intermediate information by the same process as in step S202 of the summary information generating process, instead of generating the image information based on the document information, and to generate image information based on the generated intermediate information.

Next, the following description will explain some embodiments of a communication system using the document information processing apparatus 10 of the present invention.

(First Embodiment)

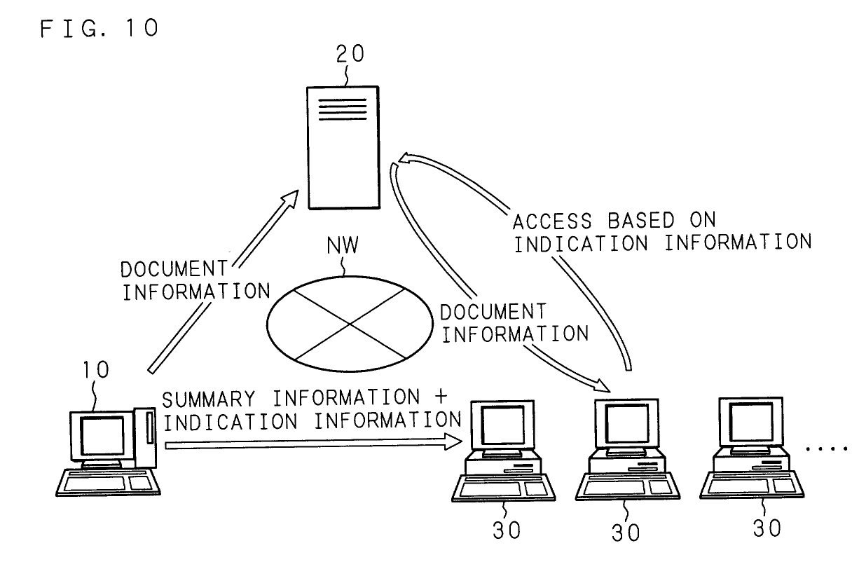

FIG. 10 is a concept view showing a communication system of the first embodiment of the present invention. The document information processing apparatus 10 is connected to a network NW such as a LAN in a company. Connected to the network NW are a recording apparatus 20 using a server computer, and a plurality of communication apparatuses 30 using client computers.

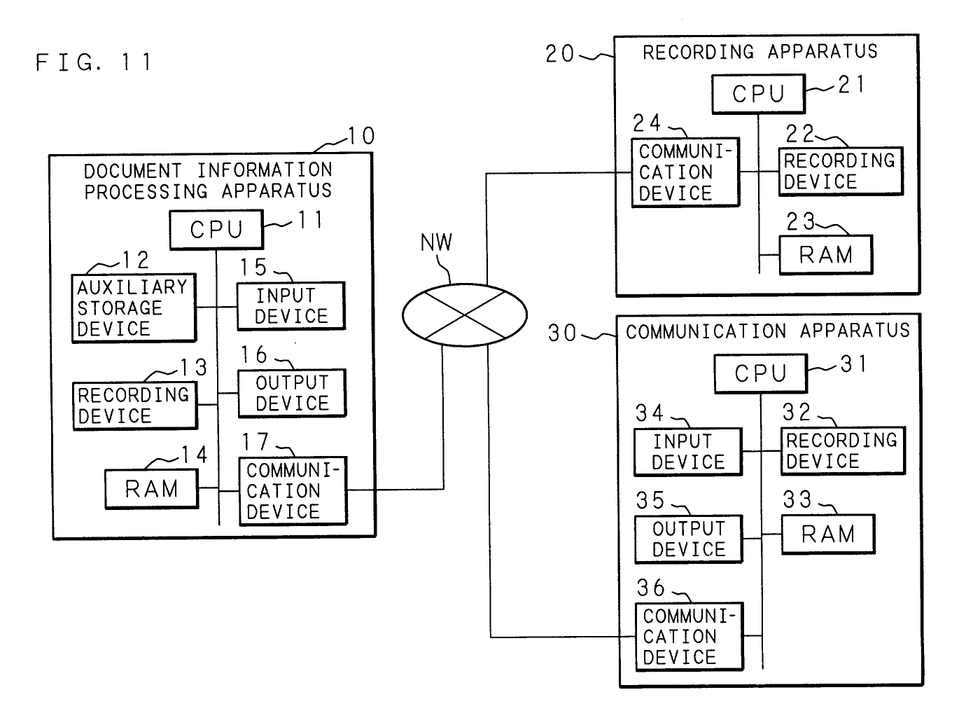

FIG. 11 is a block diagram showing the structure of the communication system of the first embodiment of the present invention. Since the structure of the document information processing apparatus 10 is the same as the structure explained using FIG. 1, the explanation thereof is omitted by referring to FIG. 1 and the explanation of that structure. The recording apparatus 20 comprises a CPU 21, a recording device 22, a RAM 23, and a communication device 24. The communication apparatus 30 comprises a CPU 31, a recording device 32, a RAM 33, an input device 34, an output device 35, and a communication device 36.

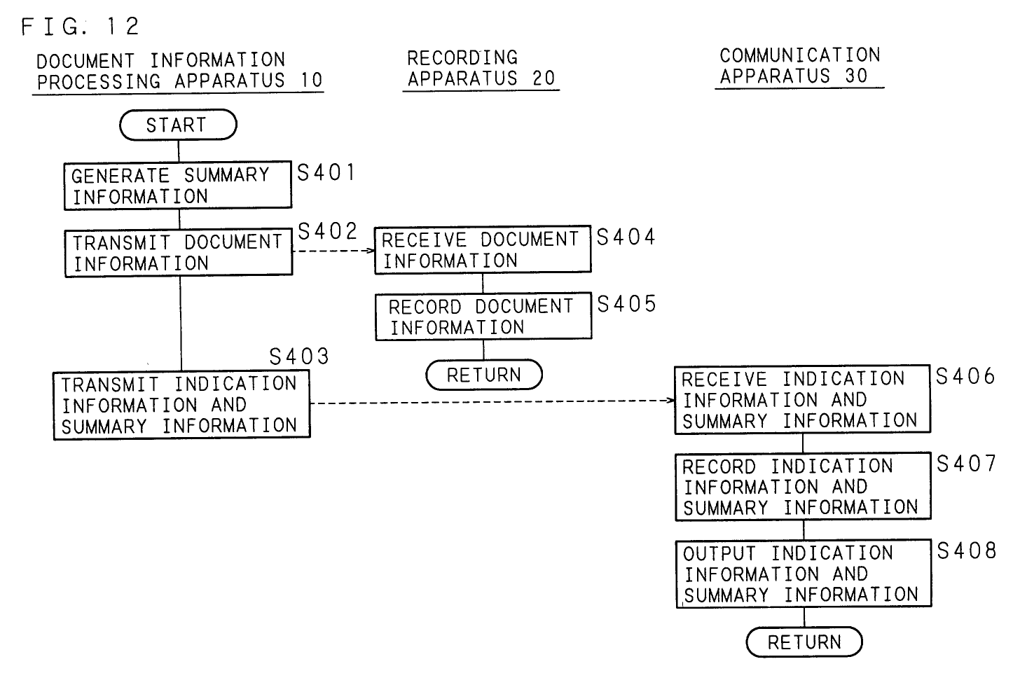

Next, referring to the flow chart shown in FIG. 12, the following description will explain the document information recording process of the document information processing apparatus 10, recording apparatus 20 and communication apparatus 30 used in the communication system of the first embodiment of the present invention.

In the document information processing apparatus 10, summary information is generated based on document information created using a document creation application (S401). Then, the document information is transmitted to the recording apparatus 20 by specifying the record position in order to record the document information in a predetermined record position of the recording apparatus 20 (S402), and indication information such as a network path indicating the record position and the summary information are transmitted simultaneously to a plurality of communication apparatuses 30 by a communication method such as electronic mail (S403).

In the recording apparatus 20, the document information is received (S404), and the received document information is recorded in the specified record position (S405). Meanwhile, in each communication apparatus 30, the indication information and summary information are received (S406), and the received indication information and summary information are recorded in the recording device 32 (S407) and outputted from the output device 35 (S408). In the case where the summary information was reversibly compressed in a format such as ZIP, LZH and CAB, the summary information is expanded during the output. An operator who operates the communication apparatus 30 can understand the content of the document information by confirming the outputted summary information, and can also perform full-text searching over the document information by using the summary information.

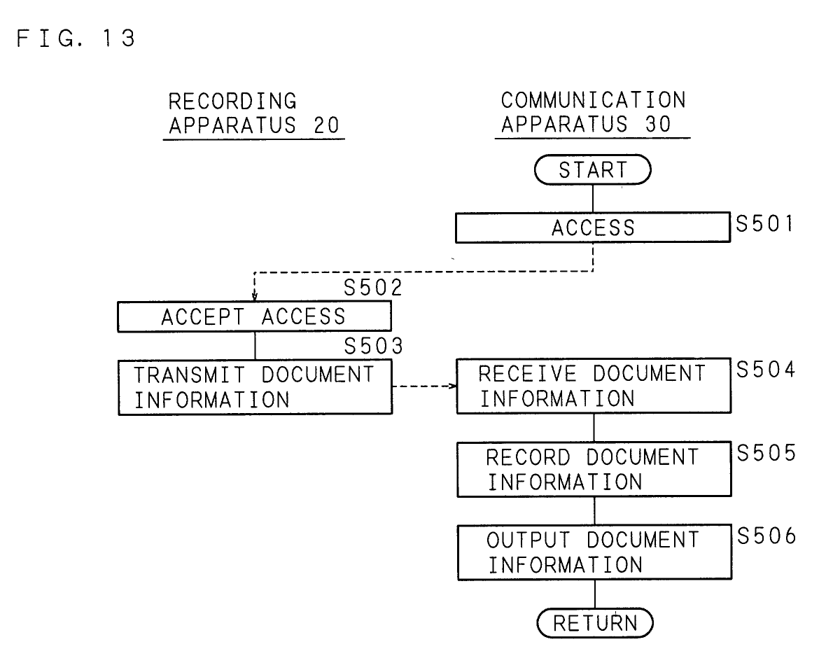

Next, referring to the flow chart shown in FIG. 13, the following description will explain the document information request process of the recording apparatus 20 and communication apparatus 30 used in the communication system of the first embodiment of the present invention.

When the operator who operates the communication apparatus 30 wants to request document information corresponding to the outputted summary information, the operator accesses the record position of the recording apparatus 20 specified by the indication information (S501). The recording apparatus 20 accepts the access (S502), and transmits the document information recorded in the specified record position to the communication apparatus 30 (S503). The communication apparatus 30 receives the document information (S504), records the received document information (S505), and also outputs the document information from the output device 35 (S506). Note that, as the information which is recorded in the recording apparatus 20 and transmitted to the communication apparatus 30 according to the need, it is possible to use the intermediate information in place of the document information.

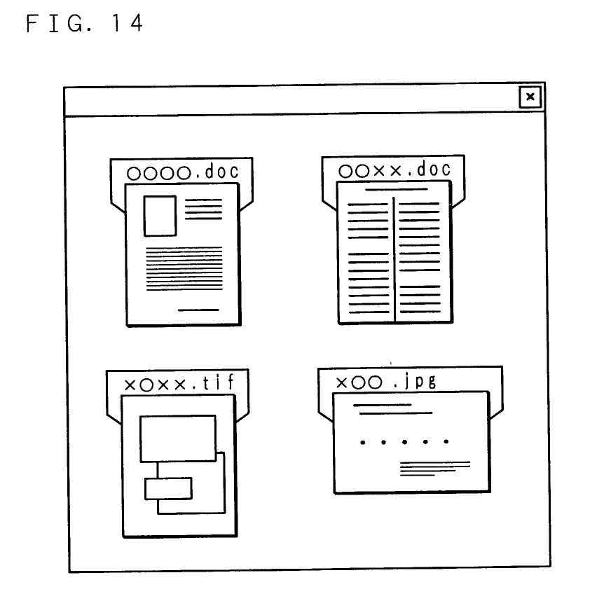

Next, the following description will explain the operation of the communication apparatus 30 used in the communication system of the first embodiment of the present invention, with reference to FIGS. 14 through 16 which are explanatory views showing images outputted from the communication apparatus 30.

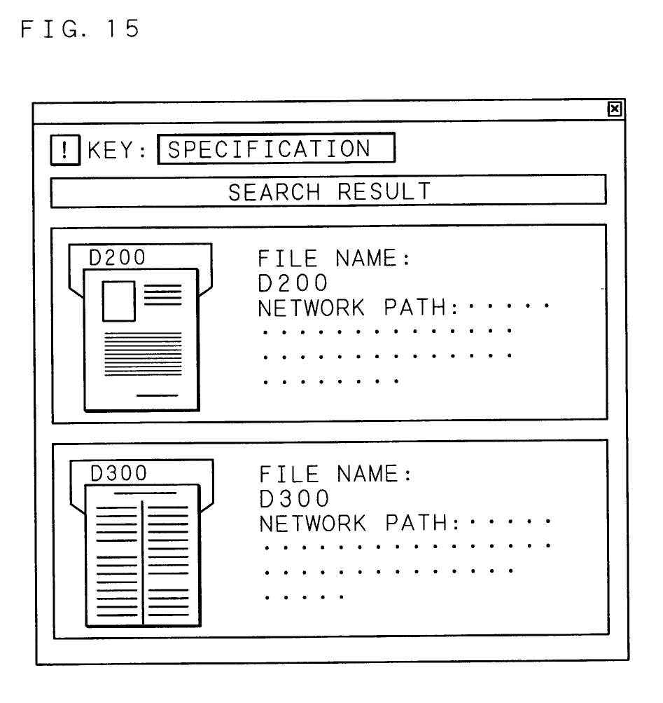

FIG. 14 illustrates a state in which the summary information recorded in the recording device 32 is outputted, and indicates that a plurality of pieces of summary information, including summary information which is not shown, are recorded in the communication apparatus 30. FIG. 15 shows a state in which the word “specification” is inputted as a key for full-text searching and the result of executing the search is outputted, and thus it is possible to confirm that two pieces of summary information having word information containing the word “specification” are extracted.

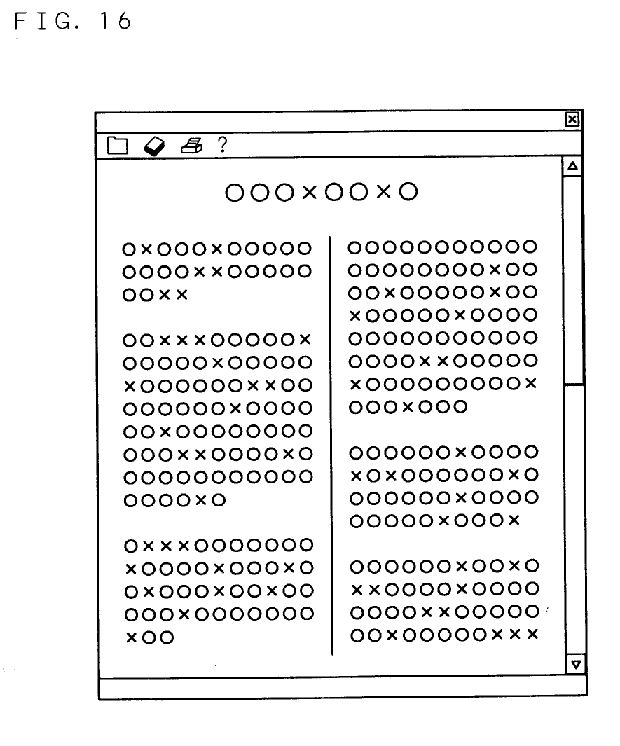

By making an input to specify an image representing the summary information shown on the left, the intermediate information contained in the summary information is displayed in an enlarged fashion, and thus it is possible to confirm the displayed intermediate information. Besides, by making an input to specify the indication information (network path) displayed on the right, it is possible to access the record position of the recording apparatus 20 specified by the indication information. Furthermore, FIG. 16 shows a state in which the document information received from the recording apparatus 20 is outputted.

(Second Embodiment)

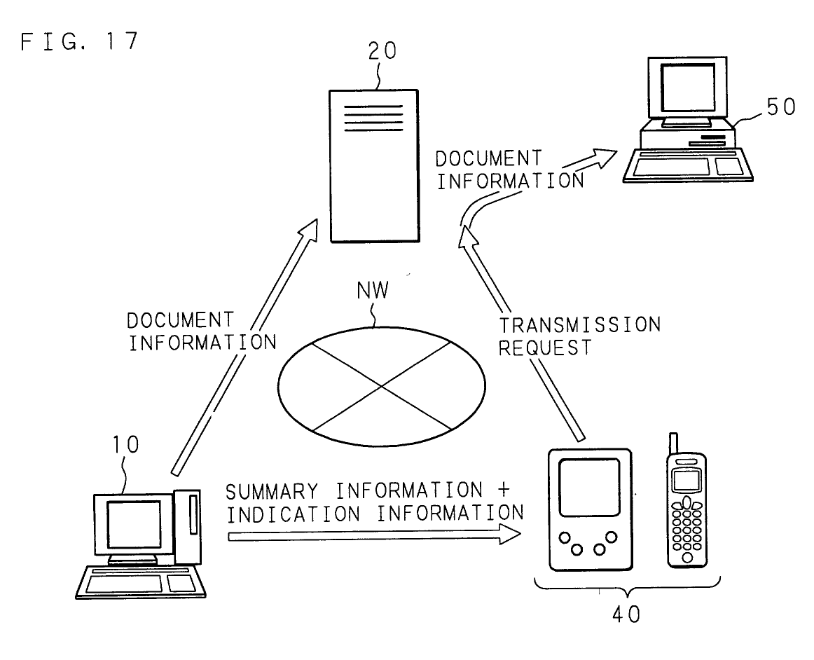

FIG. 17 is a concept view showing a communication system according to the second embodiment of the present invention. The second embodiment is a mode in which mobile communication terminal apparatuses 40 such as PDA (Personal Digital Assistants) and mobile phones are used in place of the communication apparatuses 30 of the first embodiment, and further a receiving apparatus 50 using a client computer is connected to the network NW. As the document information recording process for transmitting document information from the document information processing apparatus 10 to the recording apparatus 20 and transmitting summary information to the mobile communication terminal apparatus 40 substituting the communication apparatus 30, a process similar to the first embodiment is performed.

However, the document information request process for requesting a transmission of document information by accessing the recording apparatus 20 from the mobile communication terminal apparatus 40 is not performed, and a transfer request for transmitting destination information such as the network path of the receiving apparatus 50 to the recording apparatus 20 is made from the mobile communication terminal apparatus 40 and then the recording apparatus 20 transfers the document information to the receiving apparatus 50 specified by the destination information. Accordingly, in the receiving apparatus 50, it is possible to confirm the document information.

While the first embodiment and the second embodiment illustrate the examples of transmitting the summary information by electronic mail from the document information processing apparatus 10 to the communication apparatus 30 or mobile communication terminal apparatus 40, it is also possible to implement a mode in which the summary information is recorded on a memory product, such as a CD-ROM, flexible disk and memory card, and the summary information recorded on the memory product is read by the communication apparatus 30 or the mobile communication terminal apparatus 40, instead of on-line communication through the network NW. Furthermore, the network NW is not limited to an internal network such as a LAN, and may be an external network such as the Internet.

Although the above-described mode illustrates a mode in which a reduction of amount of information is performed when the amount of the intermediate information is large, the present invention is not necessarily limited to this mode and may reduce the amount of information without comparing the amount of the intermediate information.

According to the present invention, as described above, the intermediate information containing the same character information as in the original document information is generated, the word information is extracted from the document information or the intermediate information, the summary information is generated by adding the extracted word information to the intermediate information, and, particularly, when the data volume of the intermediate information is greater than a predetermined value set in advance, information such as color number, typefaces and formats is reduced from the intermediate information so that the summary information obtained by adding the word information to the intermediate information not only has a small data volume but also contains all the word information and is therefore usable for a searching process using character information, such as full-text searching. Accordingly, it is possible to provide significant effects, such as enabling efficient use and management of the document information.

Moreover, according to the present invention, since methods to be adopted and the priority order can be specified for a plurality of reduction methods, it is possible to provide significant effects, such as enabling generation of summary information according to the use situation of the user.

Furthermore, according to the present invention, by generating image information such as a thumbnail image which is image information reduced in the display size and irreversibly compressed in a format such as JPEG and GIF, based on the document information, and generating summary information by adding word information to the generated image information, the generated summary information not only has a small data volume but also contains all the word information and is therefore usable for a searching process using character information, such as full-text searching. Accordingly, it is possible to provide significant effects, such as enabling efficient use and management of the document information that is the source of the summary information.

As this invention may be implemented in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A document information processing method for processing document information containing character information, comprising the steps of
generating intermediate information containing same character information as in the document information, based on the document information;
extracting word information representing words from the document information or the intermediate information; and
generating summary information by adding the extracted word information to the intermediate information.

2. A document information processing apparatus for processing document information containing character information, comprising:
a first generating unit for generating intermediate information containing same character information as in the document information, based on the document information;
an extracting unit for extracting word information representing words from the character information contained in the document information or in the generated intermediate information; and
a second generating unit for generating summary information by adding the extracted word information to the intermediate information.

3. The document information processing apparatus of claim 2, further comprising:
an amount measuring unit for measuring an amount of the intermediate information;
a comparing unit for comparing the measured amount of the intermediate information with a predetermined value set in advance; and
a reducing unit for reducing the amount of the intermediate information when the amount of the intermediate information is judged to be greater than the predetermined value.

4. The document information processing apparatus of claim 3,
wherein said reducing unit implements a reduction method of deleting a part of the intermediate information.

5. The document information processing apparatus of claim 4,
wherein said part of the intermediate information is information about late pages of a document shown by the intermediate information.

6. The document information processing apparatus of claim 3,
wherein said reducing unit implements a reduction method of converting information about color.

7. The document information processing apparatus of claim 3,
wherein said reducing unit implements a reduction method of converting information about typefaces of character information.

8. The document information processing apparatus of claim 3,
wherein said reducing unit implements a reduction method of converting information about formats of a document.

9. The document information processing apparatus of claim 3,
wherein the document information contains information about graphics, and
said reducing unit implements a reduction method of converting the information about graphics.

10. The document information processing apparatus of claim 3,
wherein said reducing unit implements the steps of:
reducing the amount of the intermediate information by a first reduction method;
comparing the amount of the intermediate information after the reduction with the predetermined value; and
further reducing the amount of the intermediate information by a second reduction method different from the first reduction method when the amount of the intermediate information is judged to be greater than the predetermined value by the comparison.

11. The document information processing apparatus of claim 10, further comprising an accepting unit for accepting a priority order of the reduction methods,
wherein said reducing unit reduces the amount of the intermediate information according to the accepted priority order.

12. The document information processing apparatus of claim 2, further comprising:
a third generating unit for generating image information by irreversibly compressing the document information;
a comparing unit for comparing amounts of the generated image information and the intermediate information; and
a replacing unit for replacing the image information as new intermediate information when the amount of the image information is judged to be smaller than the amount of the intermediate information by the comparison.

13. A document information processing apparatus for processing document information containing character information, comprising:
a fourth generating unit for generating image information by irreversibly compressing the document information;
an extracting unit for extracting word information representing words from the character information contained in the document information; and
a fifth generating unit for generating summary information by adding the extracted word information to the generated image information.

14. The document information processing apparatus of claim 2,
wherein said extracting unit extracts independent words, which are extracted by a morpheme analysis, as word information from the character information.

15. The document information processing apparatus of claim 13,
wherein said extracting unit extracts independent words, which are extracted by a morpheme analysis, as word information from the character information.

16. The document information processing apparatus of claim 2, further comprising a compressing unit for reversibly compressing the generated summary information.

17. The document information processing apparatus of claim 13, further comprising a compressing unit for reversibly compressing the generated summary information.

18. A communication system comprising:
the document information processing apparatus of claim 2;
a communication apparatus for communicating with said document information processing apparatus; and
a recording apparatus for communicating with said document information processing apparatus and communication apparatus,
wherein said document information processing apparatus includes:
a recording device for recording the document information in said recording apparatus; and
a transmitting device for transmitting indication information specifying a position where the document information is recorded and the summary information, to said communication apparatus.

19. A communication system comprising:
the document information processing apparatus of claim 13;
a communication apparatus for communicating with said document information processing apparatus; and
a recording apparatus for communicating with said document information processing apparatus and communication apparatus,
wherein said document information processing apparatus includes:
a recording device for recording the document information in said recording apparatus; and
a transmitting device for transmitting indication information specifying a position where the document information is recorded and the summary information, to said communication apparatus.

20. A computer readable memory product storing a computer program for causing a computer to process document information containing character information,
wherein said memory product stores a computer program comprising the steps of:
causing the computer to generate intermediate information containing same character information as in the document information, based on the document information;
causing the computer to extract word information representing words from the document information or the intermediate information; and
causing the computer to generate summary information by adding the extracted word information to the intermediate information.
